(19) United States
(12) Patent Application Publication
(10) Pub. No.: US 2010/0148977 A1
(43) Pub. Date: Jun. 17, 2010

(54) LOCALIZATION AND DETECTION SYSTEM APPLYING SENSORS AND METHOD THEREOF

(75) Inventors: Kuo-Shih Tseng, Taichung County (TW); Chih-Wei Tang, Taoyuan County (TW); Chin-Lung Lee, Taoyuan County (TW); Chia-Lin Kuo, Taoyuan County (TW); An-Tao Yang, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/542,928

(22) Filed: Aug. 18, 2009

(30) Foreign Application Priority Data
Dec. 15, 2008 (TW) 97148826

(51) Int. Cl. G08B 21/00

(52) U.S. Cl. 340/686.1

(57) ABSTRACT

In embodiments of the invention, multiple sensors, which are complementary, are used in localization and mapping. Besides, in detecting and tracking dynamic object, the sense results of sensing the dynamic object by the multiple sensors are cross-compared, to detect the location of the dynamic object and to track the dynamic object.

This application claims the benefit of Taiwan application Serial No. 97148826, filed Dec. 15, 2008, the subject matter of which is incorporated herein by reference.

### TECHNICAL FIELD

The application relates in general to a localization and detection system applying sensors and a method thereof, and more particularly to a localization and detection system applying complementary multiple sensors and a method thereof, which localize a carrier, predict a location of an environment feature object, detect and tract a dynamic object.

### BACKGROUND

Outdoor localization systems, such as a global positioning system (GPS), have been widely applied in a navigation system for vehicles, which localize vehicles or human beings. As for indoor localization systems, there are still a number of problems to be solved so far. The difficulties which indoor localization systems encountered may be as follows. First, the electromagnetic signals are blocked easily in the indoors, so that the system may fail in receiving the satellite signals. Second, the variation of the indoor environment is greater than that of the outdoor environment.

At present, indoor localization techniques can be classified into two types, one is referred to as an external localization system, and the other one is referred to an internal localization system. The external localization system, for example, estimates the location of the robot in the 3D environment based on the relative relationship between external sensors and robot's receivers. On the other hand, the internal localization system, for example, compares the scanned data with its built-in map, and estimates the indoor location of the robot.

The external localization system has a high localization speed, but the external sensors need to be arranged beforehand. Once the external sensors are shifted or blocked, the system may be unable to localize. Moreover, if the external localization system is for use in a wide range, the number of required sensors is increased, and so is the cost.

The internal localization system has a low localization speed, but has an advantage of flexibility. Even that the environment is varied greatly, the localization ability of the internal localization system is still good if feature points are still available for localization. Nevertheless, the internal localization system needs a built-in mapping of the indoors environment to perform localization. The mapping can be established during localization if real-time performance is taken into account. In this way, the established mapping is static. Since the real world is dynamic, it is necessary to achieve localization and mapping in a dynamic environment.

The estimation for dynamic objects can be referred to as tracking. A number of radars can be used to detect a dynamic object in air, so as to determine whether an enemy's plane or a missile is attacking. Currently, such detection and tracking technologies have had a variety of applications in our daily lives, such as an application for dynamic objects detection or security surveillance.

In order to localize in the indoors with efficiency, and to improve the problem of localization error caused by vision sensors since visual sensors are disturbed by light easily, the exemplary embodiments of the invention use complementary multiple sensors to provide a system for estimating the state of the objects in 3D (three-dimension) environment and a method thereof. An exemplary embodiment utilizes an electromagnetic wave sensor, a mechanical wave sensor, or an inertial sensor, to localize a carrier and to estimate the relative location of environment feature objects in 3D environment via sensor fusion in probability model, thereby accomplishing the localization, mapping, detection and tracking on dynamic objects.

### BRIEF SUMMARY

Embodiments being provided are directed to a localization and mapping system applying sensors and a method thereof, which combine different characteristics of multiple sensors so as to provide the function of localization and mapping in the three-dimensional space.

Exemplary embodiments of a system and a method applying sensors to detect and track a dynamic object are provided, wherein homogeneous comparison and non-homogeneous comparison are performed on the sensing results of the multiple sensors, so as to detect the moving object and track it.

An exemplary embodiment of a sensing system is provided. The system comprises: a carrier; a multiple-sensor module, disposed on the carrier, the multiple-sensor module sensing a plurality of complementary characteristics, the multiple-sensor module sensing the carrier to obtain a carrier information, the multiple-sensor module further sensing a feature object to obtain a feature object information; a controller, receiving the carrier information and the feature object information transmitted from the multiple-sensor module; and a display unit, providing a response signal under control of the controller. The controller further executes at least one of: localizing the carrier on a mapping, adding the feature object into the mapping, and updating the feature object in the mapping; and predicting a moving distance of the feature object according to the feature object information, so as to determine whether the feature object is known, and correcting the mapping and adding the feature object into the mapping accordingly.

Another exemplary embodiment of a sensing method of localization and mapping for a carrier is provided. The method comprises: executing a first sensing step to sense the carrier and obtain a carrier information; executing a second sensing step to sense a feature object and obtain a feature object information, wherein the second sensing step senses a plurality of complementary characteristics; analyzing the carrier information to obtain a location and a state of the carrier, and localizing the carrier in a mapping; analyzing the feature object information to obtain a location and a state of the feature object; and comparing the mapping with the location and the state of the feature object, so as to add the location and the state of the feature object into the mapping and update the location and the state of the feature object in the mapping.

Another exemplary embodiment of a sensing method of localization and mapping for a dynamic object. The method comprises: executing a first sensing step to sense the dynamic object and obtain its first moving distance; executing a second sensing step to sense the dynamic object and obtain its second moving distance, wherein the first sensing step and the second sensing step are complementary with each other; analyzing the first moving distance and the second moving distance to predict a relative distance between the carrier and the dynamic object; determining whether the dynamic object is known; if the dynamic object is known, correcting a state of the dynamic object in a mapping, and detecting and tracking the dynamic object; and if the dynamic object is unknown, adding the dynamic object and its state into the mapping, and detecting and tracking the dynamic object.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a schematic diagram showing a localization and detection system applying sensors according to an exemplary embodiment.

FIG. 2 is a schematic diagram showing calculation of an object's location in the 3D environment by the vision sensor.

FIG. 3 is a schematic diagram showing the projection of a binocular image.

FIGS. 4A and 4B are schematic diagrams showing the detection of a distance between the carrier and an environment feature object by a mechanic wave sensor, according to an exemplary embodiment.

FIG. 5 is a flowchart of localization and static mapping according to an exemplary embodiment.

FIG. 6 is a diagram showing a practical application for localization and static mapping.

FIG. 7 is a flowchart showing an exemplary embodiment applied in detection and tracking on a dynamic feature object.

FIG. 8 is a diagram showing a practical application in which detection and tracking are performed on a dynamic feature object.

FIG. 9 is a diagram showing a practical application for localization, mapping, detection and tracking on dynamic objects according to an exemplary embodiment.

### DETAILED DESCRIPTION APPLICATION

The disclosed embodiments combine different characteristics of multiple sensors so as to provide the function of localization and mapping in the three-dimensional space. Besides, in detecting and tracking dynamic objects, the multiple sensors are used to cross-compare the object's homogeneity or non-homogeneity, and thus to detect the dynamic object and track it.

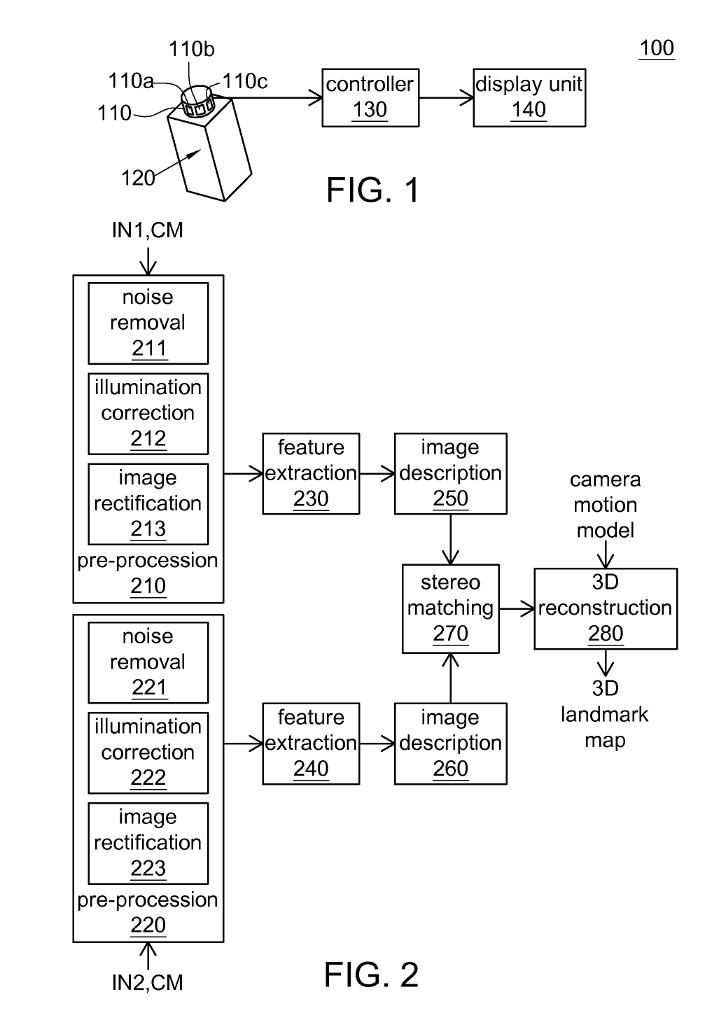

FIG. 1 is a schematic diagram showing a localization and detection system applying sensors according to an exemplary embodiment. As shown in FIG. 1, the system 100 includes a multiple-sensor module 110, a carrier 120, a controller 130, and a display unit 140.

The multiple-sensor module 110 can measure: electromagnetic wave information from the external environment or feature objects (e.g. an visible light or invisible electromagnetic wave), mechanic wave information from the external environment or feature objects (e.g. a shock wave produced from mechanical vibration of a sonar), and inertial information of the carrier 120 (e.g. a location, a velocity, an acceleration, an angular velocity, and an angular acceleration). The multiple-sensor module 110 transmits the measured data to the controller 130.

In FIG. 1, the multiple-sensor module 110 includes at least three sensors 110a, 110b, and 110c. The three sensors have different sensor characteristics, which can be complementary with each other. Alternately, the multiple-sensor module 110 can further include more sensors, and such an implementation is also regarded as a practicable embodiment.

For example, the sensor 110a is for measuring the electromagnetic wave information from the external environment, which can be a visible light sensor, an invisible light sensor, an electromagnetic wave sensor, a pyro-electric infrared sensor, or an infrared distance measuring sensor. The sensor 110b is for measuring the mechanic wave information from the external environment, which can be an ultrasonic sensor, an ultrasonic sensor array, or a sonar sensor. To be specifically, the sensors 110a and 110b can measure a distance between the carrier 120 and an environment feature object located in the external environment. The sensor 110c is for measuring the inertial information of the carrier 120, which can be an accelerometer, a gyroscope, an array of tachometers, or other sensor capable of measuring the inertial information of the carrier. The sensor 110a is disturbed easily in dim or dark environment, but the sensing result of the sensor 110a is robust to the object's appearance. On the other hand, the sensor 110b is robust to provide the measure results in dim or dark environment, but is affected by the object's appearance. In other words, the two sensors 110a and 110b are complementary with each other.

The multiple-sensor module 110 can be installed on the carrier 120. The carrier 120 can be a vehicle, a motorbike, a bicycle, a robot, a pair of glasses, a watch, a helmet, or other object capable of being moved.

The controller 130 receives the carrier's inertial information and environment sensing information, including at least a distance between the carrier 120 and the environment feature object located in the external environment, provided by the multiple-sensor module 110, thus to calculate or predict a state information associated with the carrier, to estimate the characteristic (e.g. a moving distance, or a moving direction) of the environment feature object located in the external environment, and to establish a mapping. Moreover, according to geometry equations, the controller 130 transforms the carrier's inertial information transmitted from the multiple-sensor module 110, and obtains the state information of the carrier 120 (e.g. the carrier's inertial information or gesture). In addition, according to geometry equations, the controller 30 transforms the environment sensing information transmitted from the multiple-sensor module 110, and obtains the movement information of the carrier or the characteristic of the environment feature object (e.g. the object's location).

The controller 130 derives the carrier's state from a digital filter, such as a Kalman filter, a particle filter, a Rao-Blackwellised particle filter, or other kinds of Bayesian filters, and outputs the result to the display unit 140.

The display unit 140 is connected to the control unit 130. The display unit 140 provides an interactive response to the external environment under control of the controller's commands. For example, but non-limitedly, the interactive response which the display unit 140 provides includes at least one of a sound signal, an image signal, and an indicative signal, or a combination thereof. The sound signal includes a sound, a piece of music, or a pre-recorded voice. The image signal includes an image or a texture. The indicative signal includes color, ON-OFF transition of light, flash light, or figures. For example, when it is detected that other vehicle is going to collide with a vehicle applying the embodiment, the display unit 140 can trigger a warning message, such as a sound, to inform the vehicle driver of such an event.

In an exemplary embodiment, the state estimate of the controller 130 can be implemented by a digital filter, which is described as the following equation. The denotation illustrated in this equation is given as an example wherein xₜ denotes a current carrier information, which includes a location denoted as (x,y,z), a carrier gesture denoted as (θ,φ,ψ), and a landmark state denoted as (xₙ,yₙ), while t is a time variable, xₜ₋₁ denotes a previous carrier information, uₜ denotes the current dynamic sensing information of the carrier (e.g. an accelerator denoted as (aₓ,a_{y},a_{z}) or an angular velocity denoted as (ωₓ,ω_{y},ω_{z})), and zₜ denotes the current environment information provided by the sensor (e.g. (zₓ,z_{y},z_{z})).

xₜ=f(xₜ₋₁,uₜ)+εₜ

zₜ=h(xₜ)+δₜ

By the digital filter, xₜ can be estimated by iteration. According to xₜ, the controller 130 outputs the information to other devices, such as the display unit 140.

The following description is given to demonstrate the physical concept of measuring the geometry distance of objects in the 3D environment by sensors, and a method thereof.

### Electromagnetic Wave (Visible Light)

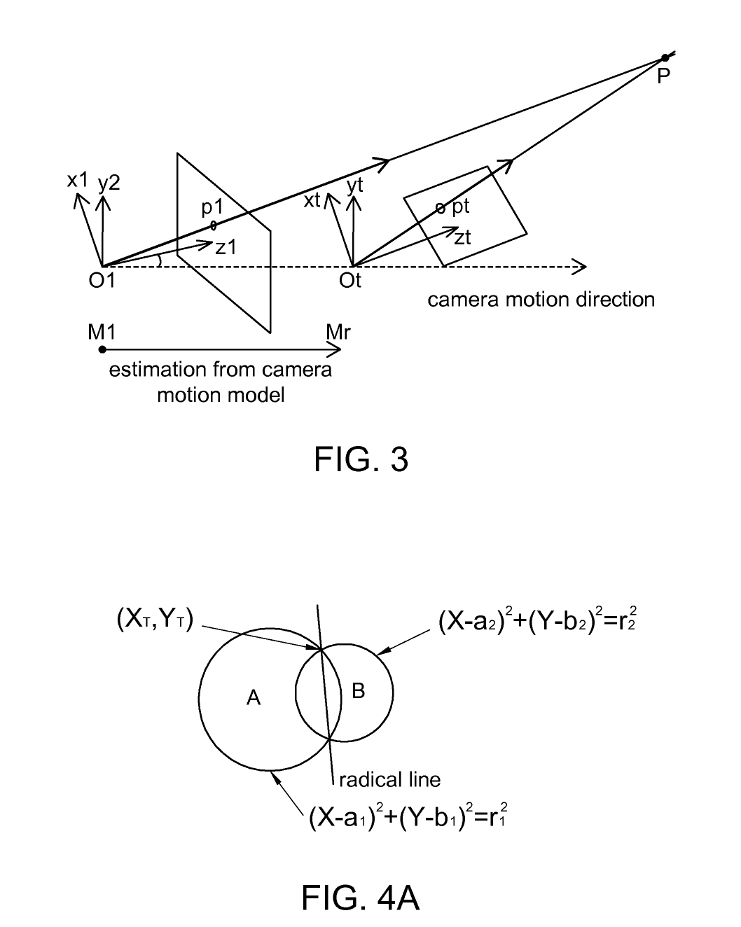

With a vision sensor, the sensed images can be used to establish an object's location and the environment information in 3D environment. On the basis of the image sensation, the real-world objects can be localized as shown in FIGS. 2 and 3. FIG. 2 is a schematic diagram showing that an object's location in the 3D environment is calculated by the vision sensor. FIG. 3 is a schematic diagram showing the projection of a binocular image.

As shown in FIG. 2, if an inner parameter matrix and an outer parameter matrix are given, then a camera matrix CM can be obtained according to the inner parameter matrix and the outer parameter matrix. Pre-processions 210 and 220 can be selectively and respectively performed on two retrieved image information IN1 and IN2, which can be retrieved by two camera devices concurrently or by the same camera sequentially. The pre-processions 210 and 220 respectively include noise removal 211 and 221, illumination corrections 212 and 222, and image rectifications 213 and 223. A fundamental matrix is necessary in performing image rectification, and derivation thereof is described below.

On an image plane, an imaging points represented by a camera coordinate system can be transformed by the inner parameter matrix into another imaging point represented by a two dimensional (2D) image plane coordinate system, i.e.

pₗ=Mₗ⁻¹ p̅ₗ

pᵣ=Mᵣ⁻¹ p̅ᵣ

where pₗ and pᵣ are the respective imaging points on a first and a second images for a real-world object point P, which are represented by the camera's coordinate system; p̅ₗ and p̅ᵣ are the respective imaging points on the first and the second images for the real-world object point P, which are represented by the 2D image plane coordinate system; Mₗ and Mr are inner parameter matrices of the first and the second cameras, respectively.

As shown in FIG. 3, the coordinate of pₗ is denoted as (x1, y1, z1), and the coordinate of pᵣ is denoted as (xt, yt, zt). In FIG. 3, both O1 and Ot denote the origin.

Moreover, pₗ and pᵣ can be transformed by an essential matrix E. The essential matrix E can be derived by multiplying a rotation matrix and a translation matrix between two camera coordinate systems. Therefore,

pᵣ^{T}Epₗ=0,

the above equation can be rewritten as:

(Mᵣ⁻¹ p̅ᵣ)^{T}E(Mₗ⁻¹ p̅ₗ)=0,

and combing Mₗ and Mr with the essential matrix E yields an equation as follows:

p̅ᵣ^{T}(Mᵣ^{-T}EMₗ⁻¹) p̅ₗ=0.

If

F=Mᵣ^{-T}RSMₗ⁻¹,

then a relationship between p̅ₗ and p̅ᵣ can be obtained as follows:

p̅ᵣ^{T}F p̅ₗ=0.

Hence, after several groups of corresponding points on two images are input, the essential matrix can be obtained according to the above equation. Epipolar lines of the two rectified images are parallel to each other.

Following that, feature extractions 230 and 240 are performed on the two rectified images, so as to extract meaningful feature points or regions for comparison. Next, the features are simplified by image descriptions 250 and 260 into feature descriptors. Then, stereo matching 270 is performed on the features of the two images, so as to find out the corresponding feature descriptors in the two images.

Assume that the coordinates of pₗ and pᵣ are └u^{l}v^{l}┘ and └u^{r}v^{r}┘, respectively. Because the images include noises, based on solution of an optimization in the 3D reconstruction 280, which is shown as follows:

$${min}_{P} {\sum }_{j = l , r} {[ \frac{{m}_{1}^{jT} P}{{m}_{3}^{jT} P} - {u}^{j} )}^{2} + {( \frac{{m}_{2}^{jT} P}{{m}_{3}^{jT} P} - {v}^{j} )}^{2} ] ,$$

the world coordinate of feature point P in the 3D environment is estimated, wherein m₁^{jT},m₂₁^{jT}, m₃^{jT} are first to third rows of the camera matrix CM, respectively. As a result, the distance between the carrier and the environment feature object can be obtained.

### Electromagnetic Wave (Energy)

In general, there are many kinds of electric equipments in the indoor environment, and these electric equipments can radiate different electromagnetic waves. As such, the electromagnetic wave's energy is useful in calculating a distance between the carrier and an object which radiates electromagnetic waves, and thus to further obtain the object's location. First, an electromagnetic wave sensor can be used to measure waveform, frequency, and electromagnetic wave energy, and an energy function can be established as follows:

$$E ( r ) = K \frac{1}{{r}^{2}} ∝ \frac{1}{{r}^{2}}$$

where E(r) denotes the energy function, K denotes a constant or a variable, r denotes the distance between the carrier and the object. The distance between the carrier and the object can be estimated according to the electromagnetic wave energy. The details thereof may refer to how to use a mechanic wave to estimate a distance between the carrier and an object, which is described in more detail later.

### Mechanic Wave (Sonar)

An ultrasonic sensor is a kind of range-only sensors, i.e. the ultrasonic sensor only senses whether an object is within certain distance but is unable to sense the accurate location of the object. Analyzing the amplitude of the mechanic wave energy, or analyzing the time difference in transmitting and receiving the mechanic wave, a distance between the carrier and a feature object is estimated. Thereafter, with two pieces of distance information which are estimated before and after the movement of the carrier, and with a location information of the carrier, the feature object's location or the carrier's location can thus be obtained.

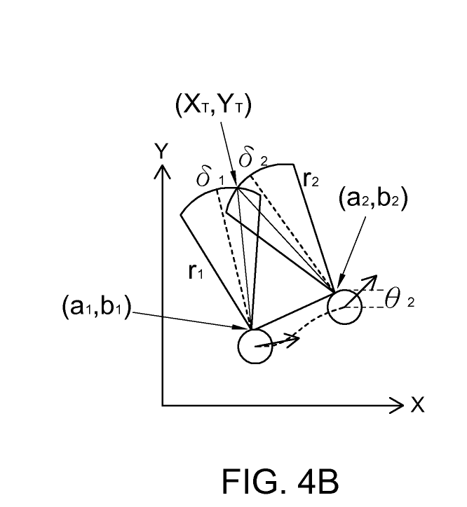

FIGS. 4A and 4B are schematic diagrams each showing that a mechanic wave sensor is used to detect a distance between the carrier and an environment feature object, and thus to predict the carrier's location in accordance to an embodiment of this embodiment.

Referring to FIG. 4A, assume that an object is at location (X1, Y1) at time point k, and at location (X2, Y2) at time point k+1, wherein a fixed sampling time Δt is between the time points k and k+1. Assume that the mechanic wave sensor is at location (a1, b1) at time point k, and at location (a2, b2) at time point k+1. According to the amplitude of the mechanic wave which the mechanic wave sensor measured at the two locations (a1, b1) and (a2, b2), or according to the time difference between transmitting and receiving, two distances r1 and r2 between the carrier and an environment feature object emitting the mechanic wave, before and after the movement of the carrier, respectively, can thus be estimated.

Next, two circles are drawn by choosing the mechanic wave sensor locations (a1, b1) and (a2, b2) as the centers, and the distances r1 and r2 as the radii, as shown by the circles A and B in FIG. 4A. The equations of the circles A and B are as follows:

circle A: (X−a₁)²+(Y−b₁)²=r₁² (1)

circle B: (X−a₂)²+(Y−b₂)²=r₂² (2)

where the radical line is the line passing through the intersection points between the two circles A and B, and the equation of the radical line can be shown as follows:

$$Y = \frac{- ( 2 {a}_{2} - 2 {a}_{1} )}{( 2 {b}_{2} - 2 {b}_{1} )} X - \frac{( {a}_{1}^{2} + {b}_{1}^{2} + {r}_{2}^{2} - {a}_{2}^{2} - {b}_{2}^{2} - {r}_{1}^{2} )}{( 2 {b}_{2} - 2 {b}_{1} )} . \qquad ( 3 )$$

Then, the relationship of the intersection points (X_{T}, Y_{T}) between the two circles A and B are assumed to be

Y_{T}=mX_{T}+n, (4)

and by substituting the equation (4) into the equation (1), it is obtained:

(X_{T}−a₁)²+(mX^{T}+n−b₁)²=r₁² [symbol] (m²+1)X_{T}²+(2mn−2mb₁−2a₁)X_{T}+(n−b₁)²+a²r₁²=0.

Further, assume that p=m²+1, Q=2mn−2mb₁−2a₁, and R=(n−b₁)²+a₁²−r₁², this yields the results as follows:

$${X}_{T} = \frac{- Q \pm \sqrt{{Q}^{2} - 4 PR}}{2 P} \\ {Y}_{T} = \frac{m ( - Q \pm \sqrt{{Q}^{2} - 4 PR )}}{2 P} + n . \qquad ( 5 )$$

Two possible solutions for (X_{T}, Y_{T}) can be obtained from above equation. Referring to the measured argument of the mechanic wave, which solution indicates the feature object's location can be determined.

A mechanic sensor is a kind of range-only sensors, i.e. the mechanic sensor only senses whether an object is within certain distance and is unable to sense accurate location of the object. A mechanic transceiver element produces a shock wave by mechanical vibration, and the mechanic transceiver element can be, for example, an ultrasonic sensor, an ultrasonic sensor array, or a sonar sensor.

### Inertial Measure Unit (IMU)

An inertial measure unit is for measuring the state of a dynamic object, such as an object in rectilinear motion or circular motion. Through computational strategies, the measured dynamic signal can be analyzed, which yields several kinds of data including location data, velocity data, acceleration data, angular velocity data, and angular acceleration data of the dynamic object in 3D space.

The sensing principle of the IMU is elaborated here. After initialization, three-axial angular velocity information of the carrier can be measured by the gyroscope, and then a three-axial gesture angles is obtained through an integration of quaternion. Next, with a transformation of coordinate transform matrix, the three-axial velocity information of the carrier in world coordinate can be obtained. During transformation, the velocity information of the carrier can be yielded by introducing the information from an acceleration sensor, conducting a first integral with respect to time, and removing the component of gravity. Afterward, a filter is adopted to obtain the predicted three-axial movement information of the carrier in 3D space.

If only this kind of sensing information is used, the difference between actual and predicted values increased gradually and diverged as time passed by due to the accumulated error caused by mathematical integration and errors from sampling of the sensors. Hence, other kinds of sensor are used to eliminate the drifted accumulation errors.

In other words, when the IMU is sensing, the operations include an operation for integration of quaternion, an operation for direction cosine convert to Euler angle, an operation for separating gravity, an operation for integration of acceleration, an operation for integration of velocity, an operation for coordinate transformation, an operation for data association, and an operation for extended-Kalman filter correction.

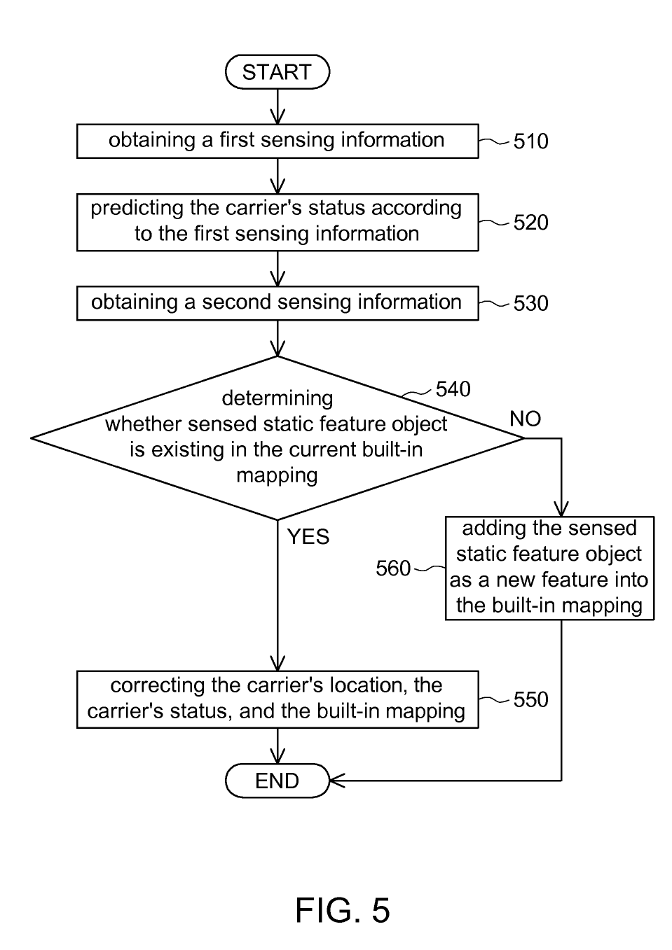

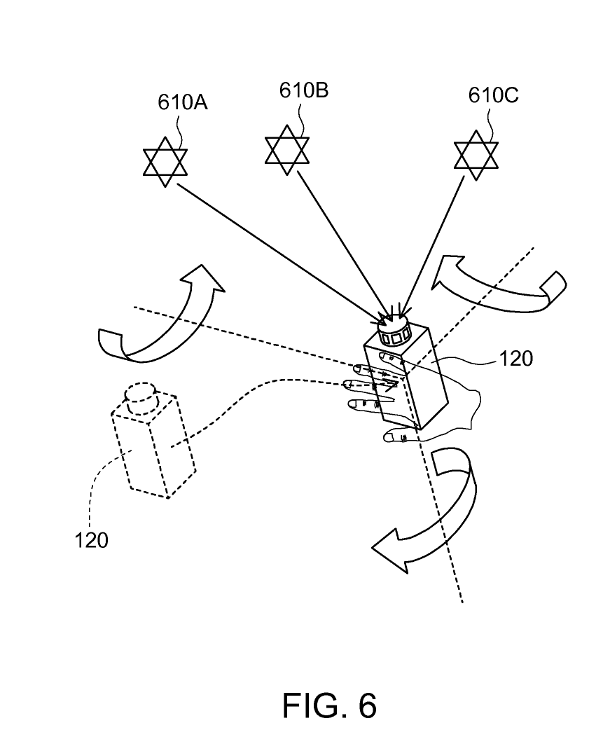

Referring to FIG. 5, how to achieve the localization and static mapping in an exemplary embodiment is described here. FIG. 6 is a diagram showing a practical application for localization and static mapping. In FIG. 6, assume that the carrier 120 is in dynamic situation, such as moving and/or rotating, and there are a number of static feature objects 610A to 610C in the external environment. In here, the carrier is to be located.

As shown in FIG. 5, in step 510, a first sensing information is obtained. The first sensing information is for the state of the carrier 120. For example, the carrier's acceleration information and velocity information detected by the sensor 110c is obtained as follows:

uₜ=[a_{x,t} a_{y,t} a_{z,t} ω_{x,t} ω_{y,t} ω_{z,t}]^{T}.

Next, in step 520, the carrier's state is predicted according to the first sensing information. Specifically, assume that the predicted location of the carrier in 3D environment is denoted as [xₜ,yₜ,zₜ,θₜ,φₜ,ωₜ], wherein

xₜ=g(xₜ₋₁,uₜ)+εₜ,

zₜ=h(xₜ)+δₜ

and assume that the motion model is given as:

Xₜ=g(Xₜ₋₁,Uₜ)+εₜ

where

Xₜ=[X_{G,t} V_{x,t} A_{x,t} Y_{G,t} V_{y,t} A_{y,t} Z_{G,t} V_{z,t} A_{z,t} e_{0,t} e_{1,t} e_{2,t} e_{3,t}]^{T}

denotes the carrier's state,
[X_{G,t} Y_{G,t} Z_{G,t}]^{T} denotes the carrier's absolute location in the world coordinate,
[V_{x,t} V_{y,t} V_{z,t}]^{T} denotes the carrier's velocity in the carrier's coordinate,
[A_{x,t} A_{y,t} A_{z,t}]^{T} denotes the carrier's acceleration in the carrier's coordinate,
[e_{0,t} e_{1,t} e_{2,t} e_{3,t}]^{T} denotes the carrier's quaternion in the carrier's coordinate, and
Uₜ=[a_{x,t} a_{y,t} a_{z,t} ω_{x,t} ω_{y,t} ω_{z,t}]^{T} denotes the carrier's acceleration and angular velocity in the carrier's coordinate.

In order to obtain the carrier's absolute location Bₜ at a timing t in world coordinate, the following information are utilized: the carrier's absolute location at a timing t−1 in world coordinate, respective integration information of acceleration and angular velocity provided by the accelerometer and the gyroscope on the carrier, and the carrier's coordinate information in the carrier coordinate is transformed into the world coordinate by the quaternion, wherein the above-mentioned steps are completed in the motion model. The matrix operation is derived as follows.

the motion model of carrier's state is:

$$[ \begin{matrix}{X}_{G , t} \\ {V}_{x , t} \\ {A}_{x , t} \\ {Y}_{G , t} \\ {V}_{y , t} \\ {A}_{y , t} \\ {Z}_{G , t} \\ {V}_{z , t} \\ {A}_{z , t} \\ {e}_{0 , t} \\ {e}_{1 , t} \\ {e}_{2 , t} \\ {e}_{3 , t}\end{matrix} ] = [ \begin{matrix}1 & {R}_{11} t & 0.5 {R}_{11} {t}^{2} & 0 & {R}_{12} t & 0.5 {R}_{12} {t}^{2} & 0 & {R}_{13} t & 0.5 {R}_{13} {t}^{2} & 0 & 0 & 0 & 0 \\ 0 & 1 & 0 & 0 & {ω}_{z , t} t & 0 & 0 & - {ω}_{y , t} t & 0 & 0 & 0 & 0 & 0 \\ 0 & 0 & 0 & 0 & 0 & 0 & 0 & 0 & 0 & 0 & 0 & 0 & 0 \\ 0 & {R}_{21} t & 0.5 {R}_{21} {t}^{2} & 1 & {R}_{22} t & 0.5 {R}_{22} {t}^{2} & 0 & {R}_{23} t & 0.5 {R}_{23} {t}^{2} & 0 & 0 & 0 & 0 \\ 0 & - {ω}_{z , t} t & 0 & 0 & 1 & 0 & 0 & {ω}_{x , t} t & 0 & 0 & 0 & 0 & 0 \\ 0 & 0 & 0 & 0 & 0 & 0 & 0 & 0 & 0 & 0 & 0 & 0 & 0 \\ 0 & {R}_{31} t & 0.5 {R}_{31} {t}^{2} & 0 & {R}_{32} t & 0.5 {R}_{32} {t}^{2} & 1 & {R}_{33} t & 0.5 {R}_{33} {t}^{2} & 0 & 0 & 0 & 0 \\ 0 & {ω}_{y , t} t & 0 & 0 & - {ω}_{x , t} t & 0 & 0 & 1 & 0 & 0 & 0 & 0 & 0 \\ 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & - 0.5 {ω}_{z , t} t & - 0.5 {ω}_{y , t} t & - 0.5 {ω}_{z , t} \\ 0 & 0 & 0 & 0 & 0 & 0 & 0 & 0 & 0 & 0.5 {ω}_{x , t} t & 1 & 0.5 {ω}_{y , t} t & - 0.5 {ω}_{z , t} t \\ 0 & 0 & 0 & 0 & 0 & 0 & 0 & 0 & 0 & 0.5 {ω}_{y , t} t & - 0.5 {ω}_{z , t} t & 1 & 0.5 {ω}_{x , t} t \\ 0 & 0 & 0 & 0 & 0 & 0 & 0 & 0 & 0 & - 0.5 {ω}_{z , t} t & 0.5 {ω}_{y , t} t & 0.5 {ω}_{x , t} t & 1\end{matrix} ] [ \begin{matrix}{X}_{G , t - 1} \\ {V}_{x , t - 1} \\ {A}_{x , t - 1} \\ {Y}_{G , t - 1} \\ {V}_{y , t - 1} \\ {A}_{y , t - 1} \\ {Z}_{G , t - 1} \\ {V}_{z , t - 1} \\ {A}_{z , t - 1} \\ {e}_{0 , t - 1} \\ {e}_{1 , t - 1} \\ {e}_{2 , t - 1} \\ {e}_{3 , t - 1}\end{matrix} ] + [ \begin{matrix}0 \\ ( {a}_{x , t} - {g}_{x , t} ) t \\ ( {a}_{x , t} - {g}_{x , t} ) \\ 0 \\ ( {a}_{y , t} - {g}_{y , t} ) t \\ ( {a}_{y , t} - {g}_{y , t} ) \\ 0 \\ ( {a}_{z , t} - {g}_{z , t} ) t \\ ( {a}_{z , t} - {g}_{z , t} ) \\ 0 \\ 0 \\ 0 \\ 0\end{matrix} ] + {ɛ}_{t}$$

and the motion model of mapping's state is:

$${[ \begin{matrix}{m}_{x , t}^{i} \\ {m}_{y , t}^{i} \\ {m}_{z , t}^{i}\end{matrix} ]}_{t} = {[ \begin{matrix}1 & 0 & 0 \\ 0 & 1 & 0 \\ 0 & 0 & 1\end{matrix} ] [ \begin{matrix}{m}_{x , t}^{i} \\ {m}_{y , t}^{i} \\ {m}_{z , t}^{i}\end{matrix} ]}_{t - 1}$$

wherein g_{x,t} denotes an X axis component of the acceleration of gravity in carrier's coordinate, g_{y,t} denotes a Y axis component of the acceleration of gravity in carrier's coordinate, g_{z,t} denotes a Z axis component of the acceleration of gravity in carrier's coordinate, εₜ denotes the noise generated by the sensor, R₁₁˜R₃₃ denotes the parameters in a direction cosine matrix.

$$[ \begin{matrix}{x}^{′} \\ {y}^{′} \\ {z}^{′}\end{matrix} ] = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] \\ [ \begin{matrix}x \\ y \\ z\end{matrix} ] = [ \begin{matrix}{e}_{0}^{2} + {e}_{1}^{2} - {e}_{2}^{2} - {e}_{3}^{2} & 2 ( {e}_{1} {e}_{3} + {e}_{0} {e}_{3} ) & 2 ( {e}_{1} {e}_{3} - {e}_{0} {e}_{2} ) \\ 2 ( {e}_{1} {e}_{2} - {e}_{0} {e}_{3} ) & {e}_{0}^{2} - {e}_{1}^{2} + {e}_{2}^{2} - {e}_{3}^{2} & 2 ( {e}_{2} {e}_{3} + {e}_{0} {e}_{1} ) \\ 2 ( {e}_{1} {e}_{3} + {e}_{0} {e}_{2} ) & 2 ( {e}_{2} {e}_{3} - {e}_{0} {e}_{1} ) & {e}_{0}^{2} - {e}_{1}^{2} - {e}_{2}^{2} + {e}_{3}^{2}\end{matrix} ] [ \begin{matrix}x \\ y \\ z\end{matrix} ]$$

According to the above-mentioned motion models, we can obtain the carrier's location [X_{G,t} Y_{G,t} Z_{G,t}]^{T} in the 3D environment, the carrier's acceleration [A_{x,t} A_{y,t} A_{z,t}]^{T} in the carrier's coordinate, the carrier's velocity [V_{x,t} V_{y,t} V_{z,t}]^{T} in the carrier's coordinate, and the carrier's quaternion [e_{0,t} e_{1,t} e_{2,t} e_{3,t}]^{T}. The carrier's state includes noises from the accelerometer and the gyroscope, which should be corrected. In this regard, another sensor is used to provide a sensor model, aiming to correct the object's state provided by the accelerometer and the gyroscope.

The sensor model is as follows:

Zₜ=h(Xₜ)+δₜ.

If the sensor is a kind of vision sensor, the sensor model is:

$$[ \begin{matrix}{z}_{x , t} \\ {z}_{y , t} \\ {z}_{z , t}\end{matrix} ] = {h}_{c , t} ( {x}_{t} ) + {δ}_{c , t} = [ \begin{matrix}{m}_{x , t}^{i} - {X}_{G , t} \\ {m}_{y , t}^{i} - {Y}_{G , t} \\ {m}_{z , t}^{i} - {Z}_{G , t}\end{matrix} ] + {δ}_{c , t}$$

wherein [m_{x,t}ⁱ m_{y,t}ⁱ m_{z,i}ⁱ]^{T} denotes coordinate of the i^{th} built-in mapping, δ_{c,t} denotes the noised form the vision sensor.
If the sensor is a kind of sonar sensor or EM wave sensor, the sensor model is:

$$\begin{matrix}{z}_{r , t} = {h}_{s , t} ( {x}_{t} ) + {δ}_{s , t} \\ = \sqrt{{( {m}_{x , t}^{i} - {X}_{G , t} )}^{2} + {( {m}_{y , t}^{i} - {Y}_{G , t} )}^{2} + {( {m}_{z , t}^{i} - {Z}_{G , t} )}^{2}} + {δ}_{s , t}\end{matrix}$$

wherein δ_{s,t} denotes the noise from the sonar sensor or electromagnetic wave sensor.

Then, as shown in step 530, a second sensing information is obtained. The second sensing information is for the static feature object in external environment (indoors). The second sensing information can be provided by at least one or both of the sensors 110a and 110b. That is, in step 530, the electromagnetic wave sensor and/or the mechanic wave sensor are used to detect the distance between the carrier and each static feature objects 610A to 610C.

Next, as shown in step 540, the second sensing information is compared with the feature objects information existing in the built-in mapping, so as to determine whether sensed static feature object is in the current built-in mapping. If yes, the carrier's location, the carrier's state, and the built-in mapping are corrected according to the second sensing information, as shown in step 550.

The step 550 is further described below. From the above sensor model, is obtained the carrier's location in the 3D environment, and further is corrected the carrier's state estimated by the motion model, so as to estimate the carrier' state, wherein the carrier's state to be estimated includes the carrier's location [X_{G,t} Y_{G,t} Z_{G,t}]^{T} in the 3D environment, and the carrier's quaternion [e_{0,t} e_{1,t} e_{2,t} e_{3,t}]^{T}. The quaternion can be used to derive several information, such as an angle θ of the carrier with respect to X axis, an angle ω of the carrier with respect to Y axis, and an angle φ of the carrier with respect to Z axis, according to the following equations:

$$\{ \begin{matrix}sin θ = 2 ( {e}_{0} {e}_{2} - {e}_{3} {e}_{1} ) \\ tan ψ = \frac{2 ( {e}_{0} {e}_{3} + {e}_{1} {e}_{2} )}{{e}_{0}^{2} + {e}_{1}^{2} - {e}_{2}^{2} - {e}_{3}^{2}} \\ tan φ = \frac{2 ( {e}_{0} {e}_{1} + {e}_{2} {e}_{3} )}{{e}_{0}^{2} - {e}_{1}^{2} - {e}_{2}^{2} + {e}_{3}^{2}}\end{matrix} .$$

After the above motion models and the sensor model are input into a digital filter, the carrier's location is estimated.

If the carrier moves without any rotation, the estimated carrier's state is denoted by xₜ=[X_{G,t} Y_{G,t} Z_{G,t}]^{T}. On the contrary, if the carrier rotates without any movement, the estimated carrier's state is xₜ=[e_{0,t} e_{1,t} e_{2,t} e_{3,t}]^{T} or xₜ=[θ ψ ω]^{T} after transformation. Both of the above two examples can be included in this embodiment.

It the determination result in step 540 is not, new features are added into the built-in mapping according to the second sensing information, as shown in step 560. That is, in step 560, the sensed static feature objects are regarded as new features on the built-in mapping, and are added in the built-in mapping. For example, after comparison, if the result shows that the feature object 610B is not in the current built-in mapping, the location and the state of the feature object 610 can be added in the built-in mapping.

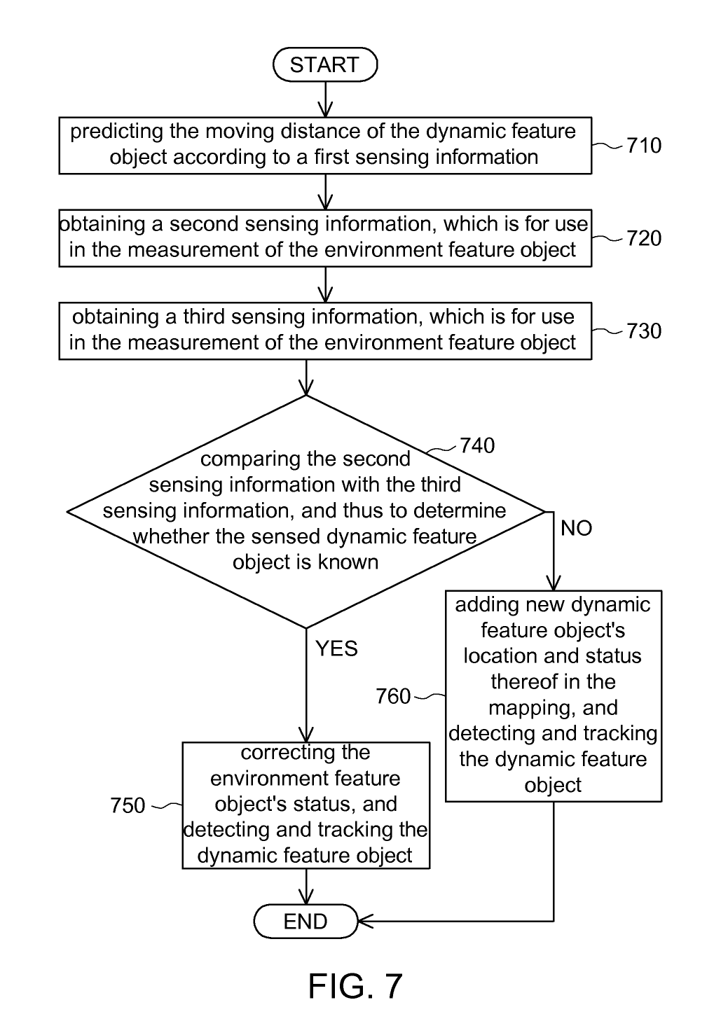

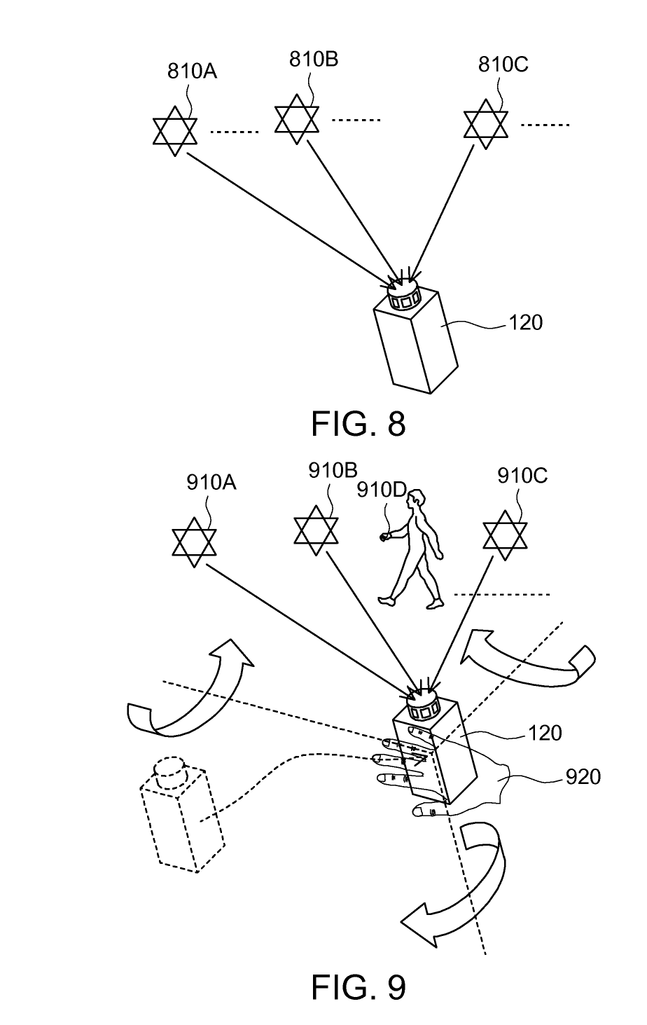

In the following description, how an exemplary embodiment is applied in detection and tracking on a dynamic feature object is described. FIG. 7 is a flowchart showing an exemplary embodiment applied in detecting and tracking on a dynamic feature object. FIG. 8 is a diagram showing a practical application for detecting and tracking a dynamic feature object. In this embodiment, it is assumed that the carrier is not in moving (i.e. static), and there are a number of moving feature objects 810A to 810C in the environment, such as in the indoors.

As shown in FIG. 7, in step 710, the moving distance of the dynamic feature object is predicted according to the first sensing information. In this embodiment, the sensor 110a and/or the sensor 110b can be used to sense the moving distance of at least one dynamic feature object by the following way.

The motion model for tracking dynamic feature object is as follows:

Oₜ=g(Oₜ,Vₜ)+εₜ,

where

Oₜ=└o_{x,t}¹ o_{y,t}¹ o_{x,t}¹ v_{x,t}¹ v_{y,t}¹ v_{z,t}¹ . . . o_{x,t}^{N} o_{y,t}^{N} o_{z,t}^{N} v_{x,t}^{N} v_{y,t}^{N} v_{z,t}^{N}┘
[o_{x,t}¹ o_{y,t}¹ o_{x,t}¹ v_{x,t}¹ v_{y,t}¹ v_{z,t}¹]^{T} denotes the first dynamic feature object's location and velocity in the 3D environment,
[o_{x,t}^{N} x_{y,t}^{N} o_{x,t}^{N} v_{x,t}^{N} v_{y,t}^{N} v_{z,t}^{N}]^{T} denotes the N^{th} dynamic feature object's location and velocity in the 3D environment, wherein N is a positive integer,
Vₜ[a_{x,t}¹ a_{y,t}¹ a_{x,t}¹ . . . a_{x,t}^{N} a_{y,t}^{N} a_{z,t}^{N}]^{T} denotes the object's acceleration in the 3D environment, and
ε_{T,t} is an error in the dynamic feature object's moving distance.

The n^{th} motion model, wherein n=1 to N and n is an positive integer, is as follows:

$$[ \begin{matrix}{o}_{x , t}^{n} \\ {o}_{y , t}^{n} \\ {o}_{z , t}^{n} \\ {v}_{x , t}^{n} \\ {v}_{y , t}^{n} \\ {v}_{z , t}^{n}\end{matrix} ] = [ \begin{matrix}1 & 0 & 0 & t & 0 & 0 \\ 0 & 1 & 0 & 0 & t & 0 \\ 0 & 0 & 1 & 0 & 0 & t \\ 0 & 0 & 0 & 1 & 0 & 0 \\ 0 & 0 & 0 & 0 & 1 & 0 \\ 0 & 0 & 0 & 0 & 0 & 1\end{matrix} ] [ \begin{matrix}{o}_{y , t - 1}^{n} \\ {o}_{y , t - 1}^{n} \\ {o}_{y , t - 1}^{n} \\ {v}_{x , t - 1}^{n} \\ {v}_{y , t - 1}^{n} \\ {v}_{z , t - 1}^{n}\end{matrix} ] + [ \begin{matrix}0.5 {t}^{2} & 0 & 0 \\ 0 & 0.5 {t}^{2} & 0 \\ 0 & 0 & 0.5 {t}^{2} \\ t & 0 & 0 \\ 0 & t & 0 \\ 0 & 0 & t\end{matrix} ] [ \begin{matrix}{a}_{x , t}^{n} \\ {a}_{y , t}^{n} \\ {a}_{z , t}^{n}\end{matrix} ] + {ɛ}_{T , t} .$$

With such motion model, estimated is the dynamic feature object's location in the 3D environment. Note that in predict of the dynamic feature object's moving distance, the acceleration is assumed to be constant but with an error; and the object's moving location can also be estimated approximately. In addition, a sensor model can further be used to correct the dynamic feature object's estimated location.

Then, as shown in step 720, obtained is a second sensing information, which is also for use in the measurement of the environment feature object, such as for measuring its moving distance. Next, as shown in step 730, obtained is a third sensing information, which is also for use in the measurement of the environment feature object, such as for measuring its moving distance.

Following that, as shown in step 740, the second sensing information is compared with the third sensing information thus to determine whether the sensed dynamic feature object is known or not. If yes, the environment feature object's state and location are corrected according to the second and the third sensing information, and the environment feature object is under detecting and tracking as shown in step 750. If the determination in the step 740 is no, which indicates that the sensed dynamic feature object is a new dynamic feature object, the new dynamic feature object's location and its state are added into the mapping, and the dynamic feature object is under detecting and tracking, as shown in step 760.

In step 740, comparison can be achieved in at least two ways, for example, homogeneous comparison and non-homogeneous comparison. The non-homogeneous comparison is that when an object has one characteristic, an electromagnetic sensor and a pyro-electric infrared sensor are used, and their sensing information are compared with each other to obtain their difference for tracking the object with one characteristic. The homogeneous comparison is that when an object has two characteristics, a vision sensor and an ultrasonic sensor are used, and their sensing information are compared with each other for their similarity and difference for tracking this object.

The sensor model used in FIG. 7 is as follows:

Zₜ=T(Xₜ)+ε_{T,t}.

wherein δ_{T,t} denotes the noise from the sensor.

If the sensor is a kind of vision sensors or other sensor capable of measuring the object's location in 3D environment, the sensor model is as follows:

$$\begin{matrix}[ \begin{matrix}{z}_{x , t} \\ {z}_{y , t} \\ {z}_{z , t}\end{matrix} ] = {T}_{c} ( {X}_{t} ) + {δ}_{T , c , t} \\ = [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ] [ \begin{matrix}{o}_{x , t}^{n} \\ {o}_{y , t}^{n} \\ {o}_{z , t}^{n} \\ {v}_{x , t}^{n} \\ {v}_{y , t}^{n} \\ {v}_{z , t}^{n}\end{matrix} ] + {δ}_{T , c , t} .\end{matrix}$$

If the sensor is an ultrasonic sensor, an electromagnetic sensor, or other range-only sensor, the sensor model is as follows:

$$\begin{matrix}{z}_{r , t} = {T}_{s} ( {X}_{t} ) + {δ}_{T , s , t} \\ = \sqrt{{( {o}_{x , t}^{n} )}^{2} + {( {o}_{y , t}^{n} )}^{2} + {( {o}_{z , t}^{n} )}^{2}} + {δ}_{T , s , t} .\end{matrix}$$

Besides, in the steps 750 and 760, a sensor model can be used to estimate the object's location in 3D environment. Through the sensor model the object's location estimated by the motion model can be corrected to obtain the object's location and velocity with higher accuracy in 3D environment, thereby achieving the intention of detecting and tracking the object.

Moreover, in still another exemplary embodiment, the localization and mapping implementation in FIG. 5 as well as the detection and tracking implementation on moving object in FIG. 7 can be combined, so as to achieve an implementation with localization, mapping, detection and tracking on moving object as shown in FIG. 9. In FIG. 9, assume that a hand 920 moves the carrier 120 in dynamic (for example, moving without rotation, rotating without movement, or moving and rotating simultaneously), while the feature objects 910A to 910C are static and the feature object 910D is dynamic. From the above description, the details about how to establish the mapping, and how to detect and tract the dynamic feature object 910D are similar and not repeated here. In this embodiment, if the carrier 120 is dynamic, the algorithm for detection and tracking is designed according to the moving carrier. Therefore, it is necessary to consider the carrier's location and its location uncertainty and predict the carrier's location, which is similar to the implementation in FIG. 5.

According to the above description, an exemplary embodiment uses complementary multiple sensors to accurately localize, track, detect, and predict the carrier's state (gesture). Hence, the exemplary embodiments can be, for example but not limited, applied in an inertial navigation system of an airplane, an anti-shock system of a camera, a velocity detection system of a vehicle, a collision avoidance system of a vehicle, 3D gesture detection of a joystick in a television game player (e.g. Wii), mobile phone localization, or a indoors mapping generation apparatus. Besides, the embodiments can also be applied in an indoors companion robot, which can monitor the aged persons or children in the environment. The embodiments can further be applied in a vehicle for monitoring other vehicles nearby, to avoid traffic accidents. The embodiments can also be applied in a movable robot, which detect a moving person, and thus to track and serve this person.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A sensing system, comprising:
a carrier;
a multiple-sensor module, disposed on the carrier, the multiple-sensor module sensing a plurality of complementary characteristics, the multiple-sensor module sensing the carrier to obtain a carrier information, the multiple-sensor module further sensing a feature object to obtain a feature object information;
a controller, receiving the carrier information and the feature object information transmitted from the multiple-sensor module; and
a display unit, providing a response signal under control of the controller;
wherein the controller executes at least one of:
localizing the carrier on a mapping, adding the feature object into the mapping, and updating the feature object in the mapping; and
predicting a moving distance of the feature object according to the feature object information, so as to determine whether the feature object is known, and correcting the mapping and adding the feature object into the mapping accordingly.

2. The system according to claim 1, wherein the multiple-sensor module comprises at least one of a visible light sensor, an invisible light sensor, an electromagnetic wave sensor, a pyro-electric infrared sensor, and an infrared distance measuring sensor, or a combination thereof.

3. The system according to claim 1, wherein the multiple-sensor module comprises at least one of an ultrasonic sensor, an array of ultrasonic sensors, and a sonar sensor, or a combination thereof.

4. The system according to claim 1, wherein the multiple-sensor module comprises at least on of an accelerometer, a gyroscope, and an array of tachometers, or a combination thereof.

5. The system according to claim 1, wherein the response signal provided by the display unit comprises at least one of a sound signal, an image signal, and an indicative signal, or a combination thereof.

6. The system according to claim 1, wherein the carrier comprises a vehicle, a motorbike, a bicycle, a robot, a pair of glasses, a watch, a helmet, and an object capable of being moved, or a combination thereof.

7. The system according to claim 1, wherein the controller predicts a state of the carrier according to the carrier information;
compares the feature object information of the feature object, which is regarded as static, with the mapping, so as to determine whether the feature object is in the mapping;
if the feature object is not in the mapping, adds a state and a location of the feature object in the mapping; and
if the feature object is in the mapping, corrects the mapping, a location of the carrier and the state of the carrier.

8. The system according to claim 1, wherein the controller
compares the feature object information of the feature object, which is regarded as dynamic, with the mapping, so as to determine whether the feature object is known;
if the feature object is known, corrects a location and a state of the feature object in the mapping, and
if the feature object is unknown, adds the state and the location of the feature object into the mapping.

9. A sensing method of localization and mapping for a carrier, comprising:
executing a first sensing step to sense the carrier and obtain a carrier information;
executing a second sensing step to sense a feature object and obtain a feature object information, wherein the second sensing step senses a plurality of complementary characteristics;
analyzing the carrier information to obtain a location and a state of the carrier, and localizing the carrier in a mapping;
analyzing the feature object information to obtain a location and a state of the feature object; and
comparing the mapping with the location and the state of the feature object, so as to add the location and the state of the feature object into the mapping and update the location and the state of the feature object in the mapping.

10. The method according to claim 9, wherein the first sensing step comprises:
sensing the carrier to obtain at least one of a velocity, an acceleration, an angular velocity, and an angular acceleration.

11. The method according to claim 10, wherein the second sensing step comprises:
sensing the feature object to obtain a relative distance relationship between the feature object and the carrier.

12. The method according to claim 10, further comprising:
comparing the location of the carrier with the location of the feature object to obtain a situation response.

13. A sensing method of detecting and tracking for a dynamic object, comprising:
executing a first sensing step to sense the dynamic object and obtain its first moving distance;
executing a second sensing step to sense the dynamic object and obtain its second moving distance, wherein the first sensing step and the second sensing step are complementary with each other;
analyzing the first moving distance and the second moving distance to predict a relative distance between the carrier and the dynamic object;
determining whether the dynamic object is known;
if the dynamic object is known, correcting a state of the dynamic object in a mapping, and detecting and tracking the dynamic object; and
if the dynamic object is unknown, adding the dynamic object and its state into the mapping, and detecting and tracking the dynamic object.

14. The method according to claim 13, further comprising:
analyzing the relative distance between the carrier and the dynamic object to obtain a situation response.

15. The method according to claim 13, wherein if the carrier is dynamic, the method further comprises:
sensing the carrier to obtain at least one of a velocity, an acceleration, an angular velocity, and an angular acceleration.
